(19) United States
(12) Patent Application Publication
(10) Pub. No.: US 2003/0120527 A1
(43) Pub. Date: Jun. 26, 2003

(54) Computer-implemented system and method for productivity enhancement

(76) Inventors: Andres Palomo, Miami, FL (US); Fernando Villacian, Miami, FL (US); Lorn Leitman, Coral Gables, FL (US)

Correspondence Address: LOTT & FRIEDLAND, P.A., P.O. BOX 141098, CORAL GABLES, FL, 33114-1098, US

(21) Appl. No.: 10/036,008

(22) Filed: Dec. 26, 2001

(51) Int. Cl. G06F 17/60

(52) U.S. Cl. 705/7

(57) ABSTRACT

An invention relating generally to the field of business efficiency, and more particularly, to a software application, which can be used locally or remotely, for inclusionary data entry and standardized report generation.

### FIELD OF INVENTION

The present invention relates generally to the field of business efficiency, and more particularly, to a software application, which can be used locally or remotely, for inclusionary data entry and standardized report generation.

### BACKGROUND OF THE INVENTION

In 1998, all physicians worked a median of 48 weeks per year and 55 hours per week in professional activities defined as patient care, teaching, research and administration. The median number of hours in professional activities for general/family practice physicians was 52; for general internists, 57; for pediatricians, 54; and for obstetricians and gynecologists, 62. Total patient visits (office visits, visits made on hospital rounds, visits made in outpatient clinics and emergency rooms) reached a median of 119 per week for general/family practice physicians, 101 for general internists, 109 for pediatricians, and 96 for obstetricians and gynecologists.

Doctors and other medical professionals generate revenue based upon the number of patients they can turn over. However, trends seem to indicate longer visits by patients and therefore, less turnover efficiency for the medical professionals that treat these patients.

Researchers examined data from two large, national databases—the National Ambulatory Medical Care Survey (NAMCS) of the National Center for Health Statistics and the American Medical Association's Socioeconomic Monitoring System. In 1989, according to NAMCS data, doctors spent an average of 16.4 minutes with fee-for-service patients—that increased to 18.5 minutes in 1998. Ten years ago doctors spent an average of 15.4 minutes with pre-paid, managed-care patients—by 1998 it increased to 17.9 minutes. The trend held whether patients were seeing primary care physicians or specialists, as well as for common or complex medical problems. Doctor revenue efficiency could be improved if the average time spent with a patient is reduced, or if the average time spent with clerical matters such as dictation are reduced.

In addition, patients are often seen by a number of medical professionals even for treatment of one affliction. This can be on a vertical or horizontal level. For example, if the patient requires repeated visits to the family practice doctor for analysis and report of lab results at the diagnosis stage, more than one doctor may be involved. Each doctor would normally take notes in his or her distinct manner. In a vertical situation, the patient could be passed along to a specialist. The specialist, not unlike the second family practice doctor, would normally keep notes differently than the original caregiver. This results in a patchwork of note styles and possible substantive deficiencies in the file, which can lead to confusion.

Medical professionals are also responsible for making “house calls” and visiting hospital in-patients. The quality of these visits could be improved by enabling the patient file data to be retrieved and edited on the fly at remote locations respective to the medical professional's primary office location.

Also of concern to today's medical health care provider is the Health Insurance Portability and Accountability Act (“HIPAA”). Passed in 1996, HIPAA is designed to protect confidential healthcare information through improved security standards and federal privacy legislation. It defines requirements for storing patient information before, during and after electronic transmission. It also identifies compliance guidelines for critical business tasks such as risk analysis, awareness training, audit trail, disaster recovery plans and information access control and encryption. These security standards for information access control and encryption may have the most significant impact on how the industry conducts its business. There are more than sixty-eight information security conditions in three areas that must be met to ensure compliance with HIPAA. These areas are:

Technical Security Services: user authorization and authentication, access control and encryption

Administrative Procedures: formal security planning, record maintenance and audits

Physical Safeguards: security to building, privacy for office and workstations that handle patient information

Many experts in the industry estimate that the impact and cost of HIPAA and the organizational changes required for implementation will significantly dwarf the expense of preparing for Y2K. Additionally, unlike one-time Year 2000 preparations, information security will become an annual IT budgetary cost for training, evaluating, inspecting and updating security systems and policies. Moreover, failure to achieve compliance with HIPAA could find hospital executives, physicians and others facing fines of up to $25,000. Certain criminal violations could cost individuals and organizations $250,000 and up to 10 years in jail! Final costs for compliance will largely depend on whether an organization's current information systems are capable of accommodating the regulation's encryption and standardization requirements. HIPAA may require system replacements if they are unable to manage the new functional requirements. Rules regarding the development, verification and security of electronic signatures may prove particularly problematic for some existing systems.

Previous attempts have been made to provide a software application, which can be used locally or remotely, for inclusionary data entry and standardized report generation, such as described in U.S. Pat. No. 6,192,345 to Chicorel (the '345 patent); U.S. Pat. No. 6,182,047 to Dirbas (the '047 patent); U.S. Pat. No. 6,157,914 to Seto, et al. (the '914 patent); U.S. Pat. No. 6,047,259 to Campbell, et al. (the '259 patent); U.S. Pat. No. 6,026,363 to Shepard (the '363 patent); U.S. Pat. No. 5,991,729 to Barry, et al. (the '729 patent); U.S. Pat. No. 5,974,389 to Clark, et al. (the '389 patent); U.S. Pat. No. 5,924,074 to Evans (the '074 patent); U.S. Pat. No. 5,842,175 to Andros, et al. (the '175 patent); U.S. Pat. No. 5,832,450 to Myers, et al. (the '450 patent); U.S. Pat. No. 5,823,948 to Ross, Jr., et al. (the '948 patent); U.S. Pat. No. 5,794,208 to Goltra (the '208 patent); U.S. Pat. No. 5,659,741 to Eberhardt (the '741 patent); U.S. Pat. No. 5,594,638 to Iliff (the '638 patent); U.S. Pat. No. 5,546,580 to Seliger, et al. (the '580 patent); U.S. Pat. No. 5,327,341 to Whelan, et al. (the '341 patent); all of which are incorporated herein by reference.

The '345 patent describes a medical progress documentation system using an organized “language” of codes that when entered into a programmed processor in a particular arrangement, will generate a descriptive sentence depicting predetermined, frequently used processes in a medical office, illustrated in FIG. 1. The printed and signed descriptive text is then entered into the patient's medical chart. One disadvantage of the '345 patent is that it is designed for use within the office setting only, and is not web enabled. Another disadvantage of this invention is that it requires code learning in order for the system to utilize its documentation entry.

The '047 patent describes a computer software system for providing a medical information log system, illustrated in FIG. 1. The log entries are associated with a medical visit and the information can be used for record keeping, outcome analysis, research, teaching, quality assurance, and/or billing. A disadvantage of the '047 patent is that it is not network compatible nor cross-platform compatible. Additionally, it is designed for use only with a surgical operative log system.

The '914 patent describes a medical support system intended to centrally manage medical information generated by more than one hospital and permit medical information interchange among hospitals with easy operations, illustrated in FIG. 2. One disadvantage of the '914 patent is that it is directed only towards a hospital setting. Another disadvantage of the invention is that the local workstations must be preprogrammed in order for the system to work.

The '259 patent describes a software system for managing a health care practice that includes interactive software tools for conducting a physical exam, suggesting tentative diagnosis, and managing a treatment protocol, illustrated in FIG. 1. A disadvantage of the '259 patent is that it is not capable of communicating over the Internet. Further, the '259 invention does not conceive of industry-wide access to an information database.

The '363 patent describes a medical history documentation system and method for recording information, illustrated in FIG. 3, in which a transcriber having a plurality of report section templates is used. One disadvantage of this patent is that a transcriber is required for its practice.

The '729 patent describes a memory storage device for generating a report that contains medical counseling information which is specific to a patient, illustrated in FIG. 1. A relational database management system is used that stores a plurality of diagnostic codes and archived textual and graphic information specific for each diagnostic code. The '729 patent suffers from being only an intra-office application. Additionally, each possible diagnosis must be assigned an individual code, with an enormous amount of diagnoses possible, this can be tedious.

The '389 patent describes a patient medical record system including a number of caregiver computers and a patient database connected to a main database management system. A predetermined set of rules includes access to certain portions of patient data, FIG. 1. One disadvantage of this invention is that it is designed to avoid access to an individual medical record by multiple caregivers simultaneously.

The '074 patent describes a medical records system that creates and maintains all patient data electronically, allowing multiple healthcare providers to simultaneously access, analyze and update a particular patient file. The program uses pen-based portable computers with wireless connections to a computer network to access patient records and several reference databases, illustrated in FIG. 24. One disadvantage of this invention is that it is form based, it uses templates and is therefore exclusionary.

The '175 patent describes a computer method and system for assisting the administration and monitoring of the therapy of patients including storing patient individual records in the memory of a computer system, illustrated in FIG. 1. A disadvantage of the '175 patent is that it does not provide for web based functionality. Additionally, the system is restricted to rehabilitation data and therapy treatment situations.

The '450 patent describes an electronic medical record system that stores data about patient encounters arising from a content generator in freeform text, illustrated in FIG. 1. A header for each encounter also uses text to store context information for each encounter record. One disadvantage of the '450 patent is that it requires various computers used for specialized functions, such as the administrative computers and the analysis workstations.

The '948 patent describes a medical records, documentation, tracking and order entry system, as illustrated in FIG. 1. A disadvantage of the '948 patent is that it is designed for input of dictated text into a digital format.

The '208 patent describes a method and apparatus for creating and using a reusable medical protocol to create a patient chart. The protocol is created by selecting various medical findings from a database containing a plurality of coded medical findings, as illustrated in FIG. 2. One disadvantage of the '208 patent is that it is intra-office only and does not contemplate integrating information with other sites.

The '741 patent describes a computer system and method for storage of individual medical histories, illustrated in FIG. 1, on a storage device, the size of which is that of a credit card including the possibility of implanting the storage device under the skin of the patient's upper torso. It is possible to add new medical data about the patient to the device and to communicate with other computers to retrieve large data records about the individual; to enable a second computer to collate; and sort data relating to selected medical fields from the data of such individuals. A disadvantage of the present invention is that it requires information to be carried on a portable storage device, such as a smartcard.

The '638 patent describes a system and method for providing computerized, knowledge-based medical diagnostic and treatment advice. The medical advice is provided to the general public over a telephone network, illustrated in FIG. 1. A disadvantage of the '638 patent is that it is merely an information database being applied to an over the telephone report. The system does not necessarily have a full medical history of the patient at its disposal, and it also does not allow for web based functionality.

The '580 patent describes a method for coordinating updates to a medical database in a medical information system that permits concurrent charting from different workstations and medical instruments. Workstations equipped with an operating system and a graphic user interface allow entry of new data at patient care facilities and provide corrections to the patient history, as illustrated in FIG. 1. One disadvantage of the '580 patent is that it is directed towards a system that allows for simultaneous data entry into a medical record.

The '341 patent describes a file maintenance system for computer processing of multiple files of a client/patient type. The files having record sets in an organizational structure combining standard, categorical, filed-defined records with identified text fields of fixed character length with a plurality of hybrid categorical, extended-field with means for editing entered text, illustrated in FIG. 1. A disadvantage of the '341 patent is that the physician is still responsible for dictating reports to be transcribed and entered into the system.

Consequently, there is a need in the art for a system and method that provides easy input and retrieval of data through internet, LAN or WAN.

There is a further need in the art for a system and method that provides standardized industry specific fields for input using an inclusionary method of input.

There is a further need in the art for a system and method that can be integrated with related segments of the industry (For example in the medical industry: pharmacy, hospital, insurance, etc.)

There is a further need in the art for a system and method that can generate standardized reports and billing reports compliant with standards required by reimbursing institutions such as Medicare, Medicaid, and insurance companies.

There is a further need in the art for a system and method that incorporates a relational database used to generate the reports upon request of industry specific applications.

There is a further need in the art for a system and method that is operating system and platform independent, eliminating proprietary obstacles to the data and allowing universal access through a browser.

There is a further need in the art for a system and method that can assist a medical service provider with HIPAA compliance.

There is a further need in the art for a system and method that can utilize best of breed applications (e.g. billing, pharmacy, security, document imaging) to provide a comprehensive office solution.

There is a further need in the art for a system and method that restricts access to system files according to a hierarchical file access control and according to pre-defined workflow constraints.

There is a further need in the art for a system and method that includes a scheduler, capable of providing data to a system user at a pre-appointed time and place.

### SUMMARY OF THE INVENTION

In a preferred embodiment of the invention, what is provided is a computer-implemented system for improving the efficiency of a business comprising: a local computer operationally connected to a network of computers, wherein the local computer is used for data input and retrieval; a relational database, wherein the relational database is operationally connected to the local computer and receives data input and requests for data from the local computer; a server computer wherein the server computer is operationally connected to the relational database and the local computer, wherein the server computer is capable of being accessed by multiple computers through the network; and, application software designed for inclusionary data entry, data retrieval and report generation, wherein the report generation is accomplished by accessing the relational database and the inclusionary data stored thereon.

In an alternate embodiment, what is provided is a computer-implemented system for improving the efficiency of a medical service provider comprising: a local computer operationally connected to a network of computers, wherein the local computer is used for data input and retrieval; a relational database, wherein the relational database is operationally connected to the local computer and receives data input and requests for data from the local computer; a server computer wherein the server computer is operationally connected to the relational database and the local computer, wherein the server computer is capable of being accessed by multiple computers through the network; and, application software designed for inclusionary data entry, data retrieval and report generation, wherein the report generation is accomplished by accessing the relational database and the inclusionary data stored thereon.

In another alternate embodiment, what is provided is a computer-implemented system for improving the efficiency of a business comprising: a local computer, wherein the local computer is used for data input and retrieval; a relational database, wherein the relational database is operationally connected to the local computer and receives data input and requests for data from the local computer; a server computer wherein the server computer is operationally connected to the relational database and the local computer; and, application software designed for inclusionary data entry, data retrieval and report generation, wherein the report generation is accomplished by accessing the relational database and the inclusionary data stored thereon.

In another alternate embodiment, what is provided is a computer-implemented system for improving the efficiency of a medical service provider comprising: a local computer, wherein the local computer is used for data input and retrieval; a relational database, wherein the relational database is operationally connected to the local computer and receives data input and requests for data from the local computer; a server computer wherein the server computer is operationally connected to the relational database and the local computer; and, application software designed for inclusionary data entry, data retrieval and report generation, wherein the report generation is accomplished by accessing the relational database and the inclusionary data stored thereon.

In another alternate embodiment, what is provided is a method for improving the efficiency of a business comprising: acquiring data to be input utilizing an inclusionary method; inputting inclusionary data into a relational database; processing data, wherein said processing is accomplished by a software application designed for inclusionary data entry, data retrieval and report generation, the report generation accomplished by accessing the relational database and the inclusionary data stored thereon; accessing the data via a non-platform specific browser; and, generating reports from the data at the request of the software application, wherein the report generation is performed in a standardized, pre-formatted manner.

In another alternate embodiment, what is provided is a method for improving the efficiency of a medical service provider comprising: acquiring data to be input utilizing an inclusionary method, wherein the data is generated by a patient examination; inputting inclusionary data into a relational database; processing data, wherein the processing is accomplished by a software application designed for inclusionary data entry, data retrieval and report generation, the report generation accomplished by accessing the relational database and the inclusionary data stored thereon; accessing the data via a non-platform specific browser; and, generating reports from the data at the request of the software application, wherein the report generation is performed in a standardized, pre-formatted manner.

In another alternate embodiment, what is provided is a computer-readable medium storing computer executable instructions for performing the steps of: acquiring data to be input utilizing an inclusionary method; inputting inclusionary data into a relational database; processing data; accessing the data via a non-platform specific browser; and, generating reports from the data at the request of the executable instructions, wherein the report generation is performed in a standardized, pre-formatted manner.

Accordingly, it is an object of the present invention to provide a system and method that allows for easy input and retrieval of data through Internet, LAN or WAN.

It is another object of the present invention to provide a system and method that implements standardized industry specific fields for input using an inclusionary method of input.

It is another object of the present invention to provide a system and method that can be integrated with related segments of the industry (For example in the medical industry: pharmacy, hospital, insurance, etc.)

It is another object of the present invention to provide a system and method that can generate standardized reports and billing reports compliant with standards required by reimbursing institutions such as Medicare, Medicaid, and insurance companies.

It is another object of the present invention to provide a system and method that incorporates a relational database used to generate the reports upon request of industry specific applications.

It is another object of the present invention to provide a system and method that is operating system and platform independent, eliminating proprietary obstacles to the data and allowing universal access through a browser.

It is another object of the present invention to provide a system and method that can assist a medical service provider with HIPAA compliance.

It is another object of the invention to provide a system and method that can utilize best of breed applications (e.g. billing, pharmacy, security, document imaging) to provide a comprehensive office solution.

It is another object of the invention to provide a system and method that restricts access to system files according to a hierarchical file access control and according to pre-defined workflow constraints.

It is another object of the invention to provide a system and method that includes a scheduler, capable of providing data to a system user at a pre-appointed time and place.

These and other objects, features and advantages of the present invention may be better understood and appreciated from the following detailed description of the embodiments thereof, selected for purposes of illustration and shown in the accompanying drawings.

### BRIEF DESCRIPTION OF THE DRAWINGS

FIG. 1 is a schematic view of a preferred embodiment of the web-based system according to the invention.

FIG. 2 is a schematic view of a preferred embodiment of the hand-held computer based system according to the invention.

FIG. 3 is a schematic view of a preferred embodiment of the office-based based system according to the invention.

FIG. 4 is a screenshot illustrating the initial data entry screen.

FIG. 5 is a screenshot illustrating the data input by inclusion screens at a high level.

FIG. 6 is a screenshot illustrating a lower level data entry screen.

### DETAILED DESCRIPTION OF THE PREFERRED EMBODIMENT

The fundamental principle of the present invention is the development of industry specific software applications, which make use of generic technology to enhance productivity specific to the industry. The generic components are relational databases, browsers and network connectivity. The unique elements are the industry specific relational databases and the applications, which input the data and process the data with industry specific logic to provide the desired output. Browsers, which need not be platform specific, will access the application through a network connection. The application will provide industry specific fields of data for input. The data will be stored in the relational database, which in turn will be accessed by the application to generate the desired output. The output can be stored generically or can be recalled again by the application. The uniqueness of this model is based solely on the relationship which exists among all the elements within the data fields, and the logic in the application to provide the desired output. The effort to develop, a complete and logical relational database as well as the accompanying application that mimics the workflow within a particular industry, leads to competitive advantages that result in enhanced efficiency.

The browser may be from any software platform. The network can be local, wide area or Internet based. The application and the database are designed to sit on web servers, which can be local, wide area or Internet based. Thus geographic constraints are eliminated and uniform operating system platforms are not a necessity. In this manner, a centralized and redundant storage of data and application that is widely accessible is provided. It is the industry specific logic and data relationships, which mimic the workflow of the system user that provides the enhanced working environment and changes the way business is conducted. With this functionality, system users have a wide range of options and characteristics that are presently unavailable in today's market to make their business processes more efficient.

The present invention has been developed to function in three different platforms for flexibility and ease of use:

as a web-based application that can be run from a hosted central server in traditional ASP format, whereby users of the system can connect via the Internet and have access to all their data online without having to invest in additional equipment or hardware in their offices;

as a tool on a handheld or wireless device (e.g. Palm, Pocket PC or WAP enabled device), which allows users of the system mobility and portability for their data; and

as an in-house software package that runs in at the business office for security and speed, but is still backed-up at the hosted central site.

In the medical industry, the analysis begins at the interface between the patient and the caregiver. The interface is obviously dependent on location, which immediately defines the workflow of services rendered to a patient. Hospitals, doctors office, rehab centers, diagnostic centers, extended living facilities and nursing homes are some of the examples which define the workflow of services provided to patients. The next level of workflow analysis is who renders the service. Physicians, nurses, physical therapist, pharmacist are examples of the service providers in the medical service industry. In another industry, service providers could be clerks, secretaries, and business executives, for example. The next level of analysis is the type of service rendered. In the case of physicians this is determined primarily by the diagnostic codes, the service provided and the acquisition of data to reach a medical conclusion for treatment.

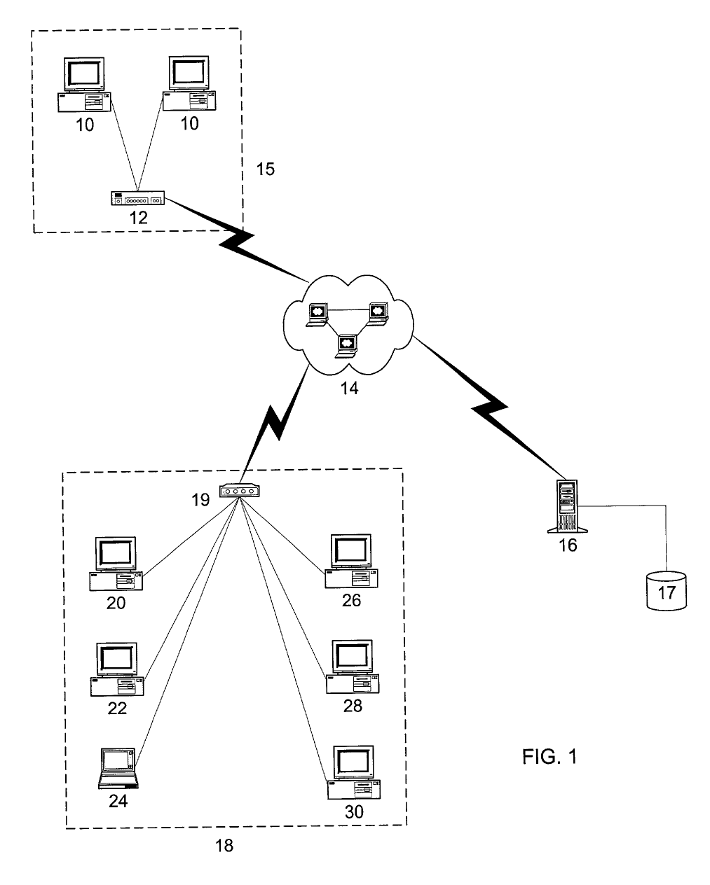

Referring initially to FIG. 1 of the drawings, in which like numerals indicate like elements throughout the several views, in a preferred embodiment the present invention is based on a web enabled platform. Local computers 10 are typically situated at the business site 15 (e.g. doctor's office). These computers 10 are used to input information collected at the local office 15 and can be essentially any kind of platform that allows for accessing other computers through a global network of computers 14 (i.e. Internet). The computers would typically transmit through a router 12, or a similar Internet 14 interface device. The data transmission would then pass through the Internet 14 and to an Internet connected server 16 which is running the application software in traditional ASP format. The server 16 being connected to a relational database 17 for data storage. The data stream can also go from the server 16 back to the local office 15 when information is requested at the local computers 10. In addition to data transmission back to the local office 15, it is possible through the present invention to retrieve information stored in the database 17 from locations 18 where the information would be desired. Such locations 18 in the medical industry example could include the patient 20, a pharmacy 22, a hospital, 24, an insurance company 26, another medical office 28 (should the patent switch doctors, for example) or a government agency 30 (e.g. Medicare). As with the business office 15, the locations 18 have a connection 19 to the Internet 14.

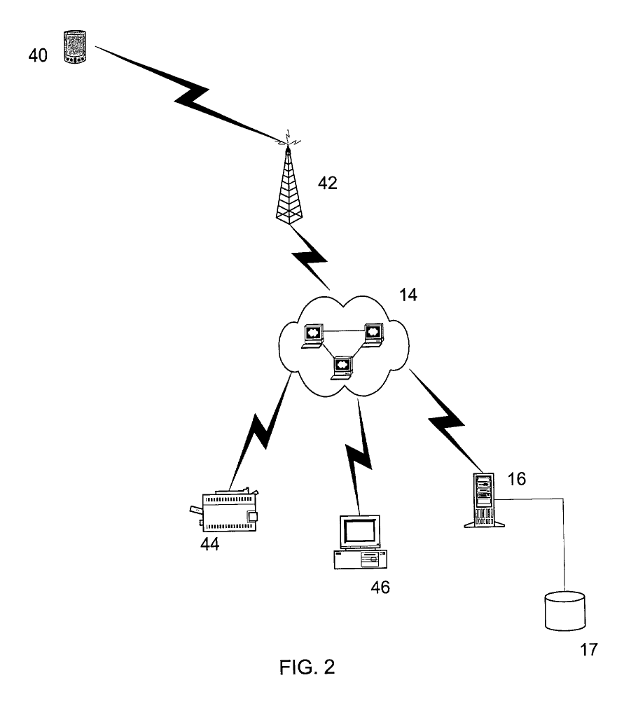

Turning now to FIG. 2, a preferred embodiment of the handheld computer based system is depicted. The hand held computer 40 is used by a service provider to input data into the system utilizing the software application loaded onto the hand held computer 40. Signals from the hand held computer 40 are transmitted to the communications network 42 which are then transmitted through the Internet 14 to an Internet or network connected printer 44, a computer 46 or to the system server 16 and its relational database 17. The service provider can also retrieve data from the relational database 17 using the hand held computer 40. As with the embodiment illustrated in FIG. 1, the database 17 can be accessed by other entities that may have use for the data.

In an alternative embodiment of the hand held system, operation could be implemented in a similar fashion to the web enabled platform, whereby the software application does not reside on the hand held computer 40, but rather on the system server 16. The distinction between the two embodiments of the hand held system is whether the application software is stored at the user's location on the hand held computer 40, or whether the application is stored on a system server 16. In the case of the application being stored on the system server 16, the graphic interface would be presented by reception by the hand held computer 40 of the interface transmitted by the system server 16 over the communications network 42 and the Internet 14. It is possible in the other two embodiments (i.e. the web based and the local network based systems) that the application software be stored locally, in a similar manner.

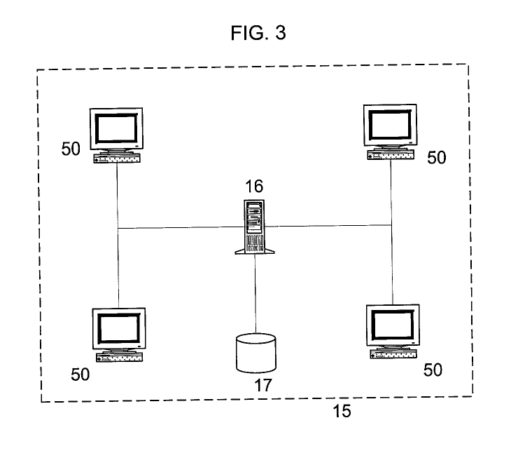

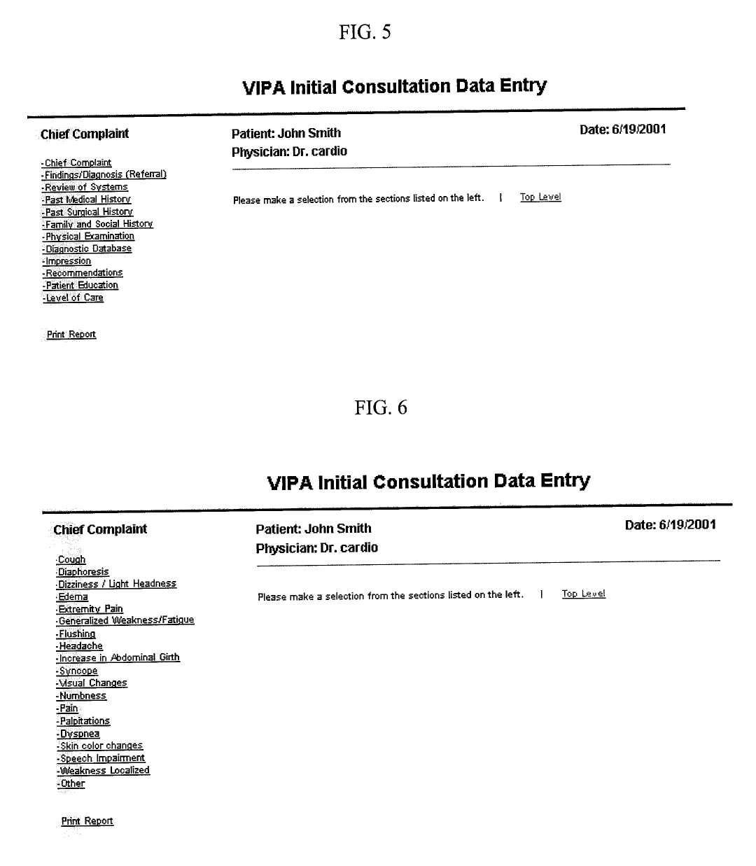

FIG. 3 is an illustration of the local network based system. In this configuration, the software is run on the local office 15 network server 16. The server 16 uses a relational database 17 for data storage. The user workstations 50 located throughout the office 15 are capable of inputting and retrieving data from the server 16 and the database 17. As with the embodiment illustrated in FIG. 1, the database 17 can be accessed by other entities that may have use for the data. The application software effectuates a newly developed approach to the process of initiating and maintaining office consultations. Using it's unique selection by inclusion approach, doctors can easily click through a predefined set of screens, examples of which are illustrated in FIGS. 5 and 6, and emerge with a report that is one third of the size of standard reports in the field. It is this process that allows doctors to navigate through the program selecting diagnostic and patient information that is relevant to the consultation, without having to deal with the myriad of cumbersome options that other software packages encompass.

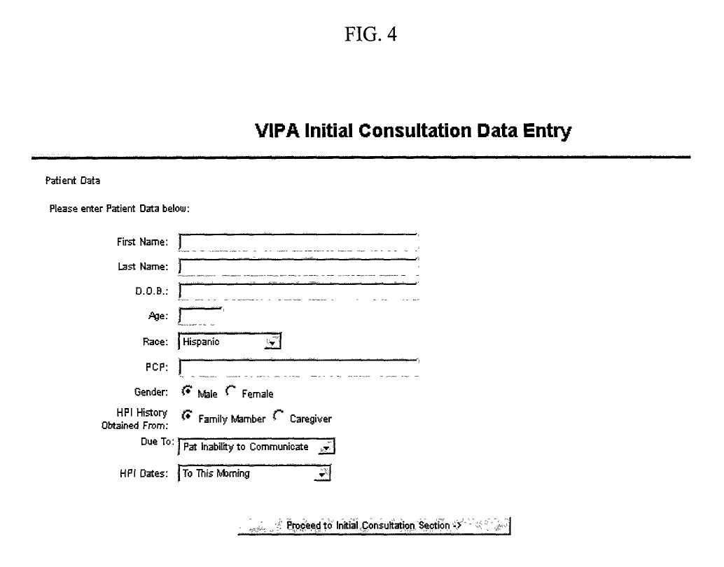

Patient demographic information is captured to assign and maintain a living database of reports, testing and visits that will be available to the doctors anywhere at anytime. The initiation of the patient visit sets the stage for a historical digital account of their medical life. FIG. 4 illustrates an example of the initial data entry screen.

High-level section identifiers for all possible diagnoses and tests are available to the doctors throughout their consultation process. Every different area of review or analysis is shown and accessed by the physician for a full and comprehensive review of the patient. The application is highly detailed and its hierarchical information/process flow allows doctors to maneuver within the program and list an unlimited amount of clinical information on the patient. Each area of diagnoses collapses into smaller subdivisions (similar to a file manager) enabling the doctor to input, and more importantly access, critical patient information rapidly.

The report generator is an inclusive task, which uniquely mimics the thought process of the doctor. Up to now, most electronic medical records were either template based or exclusive in how the report is generated. Thus it was not clear to payers whether the report was unique to the patient or whether a cookie cutter was used for the purpose of generating bills. The report generated by the method described above contains in its data fields all of the elements to provide a report output that is unique to the test or the encounter with the medical service provider. A computation of all the possible combinations of the data fields used to generate a report results in greater than 10 to the 40000 power of reports for encounters. An unimaginable number which only serves to prove that the uniqueness of the report is determined by the patient and doctor interface. Therefore the report generated by the encounter or test will be unique and not subject to previous criticism of electronic medical records. An additional benefit of standardized report generation is that it creates a norm for offices with multiple doctors. The software normalizes the different styles and processes into a single standard that can be used to cross-consult or follow up different patients with little or no difference in the data entries and final report formats.

Furthermore, the fact that the data is contained in a relational and searchable database allows for the analysis of the data in ways not previously available. For example, the percentage of patients who smoke in a particular practice could be calculated immediately, The frequency of initial chief complaints initializing a consult could be obtained and tracked real time, the number of diagnostic tests per patient encounter would be known. Additionally the medical record would be portable through a network without platform specific software. A browser would be the only tool necessary to access the record with the appropriate security clearance. The application software can also be integrated with best of breed applications for other business-related functions, such as billing, pharmacy, document imaging, general security, etc. Finally the ownership of the record could be defined.

The resulting business suite contains all the patient encounters and testing organized as report generators to document the service provided. Each report contains it's own relational database which is used by the application to enter data and generate a report. The report generated is consistent with acceptable requirement for reporting of medical services for the purpose of reimbursement. The relational database of each report relates and can be called by other reports. The call to the data can be field specific or report based. Thus the business model of the medical service provider is changed in many ways.

On the technical side, the automatic diagnosis tool (“ADT”) is a comprehensive set of relationship focused databases that contain an infinite number of conditional assessments. These assessments are a result of all related symptoms, diagnoses and test results and their associated possible outcomes. This implies an extremely large database that encompasses all of the elements within the application software. It is because of these relationships, that in the design of the ADT, it accounts for an infinite number of combinations (practically).

These conditions and outcomes are decreed by doctors, and only cease to generate more when the doctors run out of possible outcomes. The databases will be created in a way that the addition of a possible outcome can be generated on the fly by appropriate personnel with access to the knowledge base.

The system will consist of over 200 tables, each with specific input as to the relationship its particular group of elements is associated with. The database elements and tables will be created in “similarity groups” to speed up the associations within the core database. Once these are created, it will be program logic that will take information entered by the doctor and group the appropriate elements into a pool of test results, findings, etc., that will in turn generate the proposed and suggested final outcome that the doctor will still be able to modify at his leisure. Use of the present application software also reduces costs of the traditional medical office by the elimination of transcription, as well as various other administrative costs. The knowledge base is not a simple compendium of additional information. The ADT is repository for conditional situations and relationships based upon the mountains of information already stored within the system. ADT should be represented as an additional decisionmaker, or second opinion generator.

The hospital is another location where the present business model could be applied. Data related to the hospital stay would be inputted in the appropriate relational databases using the appropriate application. The categories would include but not be limited to vital signs, nurses notes, pharmacy, doctors notes, medical interventions, radiology reports, laboratory data etc. The purpose of these relational databases would be to allow the doctor to access the data, formulate his care plan, and document the care in a manner similar to the cardiology example. The unique aspects of the hospital suite would be to mimic the workflow of the different data categories to provide the data in a readily accessible and searchable format to the physician. Another unique aspect of the hospital suite would be to mimic the workflow of physicians of different specialties. Finally standardization of reports based on diagnostic codes specific for specialty would prevent commingling of diagnosis for the purpose of billing.

In addition to providing traditional network related security (or being able to be integrated with a best of breed network security module), such as firewalls and authenticated access to the network, the present invention also provides hierarchical file access control, or file access security, which when implemented correctly assists a medical service provider with HIPAA compliance. This means that certain personnel have certain access rights to files depending on the access level assigned to them by the system administrators. Ideally, the access rights granted would mimic the normal office workflow. As an example, it is likely that a medical service provider (e.g. doctor) would have full access to a patient's medical file. However, a receptionist at the front desk may only have access to certain narrow segments of the same file for scheduling purposes. As another example, a medical technologist may have access to the portion of the patient's file that relates to medical testing but not necessarily to the past general medical history contained in the file. The system would be configurable by the system administrators to define each access level. A patient is another example of a person who could have certain defined access rights.

In addition to file access security, the present invention can also provide process access security. That is, as a file progresses through an office, there are various personnel who need to enter data into that file for specific purposes, in addition, these personnel need to be allowed access to a particular file or a particular section of that file for only as long as is needed to input that data. The system is configured to preclude aforesaid personnel from viewing that same section when data input is not necessary. As opposed to file access, which discriminates based on users' access to sections of the file, process security discriminates with regard to specific sections and when typical office workflow requires that certain personnel have access to that section. The application would allow complete configuration flexibility to add, delete and modify sections of a file, users, user access rights, and workflow definitions.

The application software also provides a scheduling feature which can enhance the ability of the system user to retrieve data in a timely fashion. The system could be configured in a manner that allows it to push data to the user based on a schedule that defines when certain information would be needed. For example, a doctor's schedule is prearranged with various appointments during a workday, vital information necessary for each appointment could be presented to the doctor in the doctor's office just prior to the appointment or even on a computer in the examining room when the doctor is with the patient. In other words, if the doctor is scheduled to see Mr. Smith at 2 pm, Mr. Smith's file could be transmitted to a computer in the doctor's office for examination at a pre-set time before the appointment and also to a computer in the examining room at the time of the appointment so that the doctor can retrieve information while visiting the patient. The application could be implemented similarly for a hand held computer system where, for example, the doctor might be making rounds at a hospital.

Accordingly, it will be understood that the preferred embodiment of the present invention has been disclosed by way of example and that other modifications and alterations may occur to those skilled in the art without departing from the scope and spirit of the appended claims.

What is claimed is:

1. A computer-implemented system for improving the efficiency of a business comprising:
a local computer operationally connected to a network of computers, wherein said local computer is used for data input and retrieval;
a relational database, wherein said relational database is operationally connected to said local computer and receives data input and requests for data from said local computer;
a server computer wherein said server computer is operationally connected to said relational database and said local computer, wherein said server computer is capable of being accessed by multiple computers through said network; and,
application software designed for inclusionary data entry, data retrieval and report generation, wherein said report generation is accomplished by accessing said relational database and the inclusionary data stored thereon.

2. The computer-implemented system of claim 1 wherein said local computer is a handheld computer.

3. The computer-implemented system of claim 1 wherein said system capable of being integrated with modular software components for billing, pharmacy integration, document imaging and security.

4. The computer-implemented system of claim 1 wherein said network can be a local area network, wide area network or a global network of computers.

5. The computer-implemented system of claim 1 wherein said application software is further designed to restrict access to system files according to a hierarchical file access control.

6. The computer-implemented system of claim 1 wherein said application software is further designed to restrict access to system files according to pre-defined workflow constraints.

7. The computer-implemented system of claim 1 wherein said application software is further designed to include a scheduler which is capable of providing data to a system user at a pre-appointed time and place.

8. The computer-implemented system of claim 1 wherein said application software report generation capability also includes report generation for statistical analysis of all or a portion of the data in said relational database.

9. The computer-implemented system of claim 1 wherein said application software utilizes an automatic diagnosis tool to take information entered by a system user and group the appropriate elements into a pool of test results, findings, etc., that will in turn generate a proposed and suggested final outcome that can be modified by said system user.

10. A computer-implemented system for improving the efficiency of a medical service provider comprising:
a local computer operationally connected to a network of computers, wherein said local computer is used for data input and retrieval;
a relational database, wherein said relational database is operationally connected to said local computer and receives data input and requests for data from said local computer;
a server computer wherein said server computer is operationally connected to said relational database and said local computer, wherein said server computer is capable of being accessed by multiple computers through said network; and,
application software designed for inclusionary data entry, data retrieval and report generation, wherein said report generation is accomplished by accessing said relational database and the inclusionary data stored thereon.

11. The computer-implemented system of claim 10 wherein said local computer is a handheld computer.

12. The computer-implemented system of claim 10 wherein said local computer is located in a hospital.

13. The computer-implemented system of claim 10 wherein said local computer is located in a doctor's office.

14. The computer-implemented system of claim 10 wherein said local computer is located in a rehabilitation center.

15. The computer-implemented system of claim 10 wherein said local computer is located in a diagnostic center.

16. The computer-implemented system of claim 10 wherein said local computer is located in an extended living facility.

17. The computer-implemented system of claim 10 wherein said local computer is located in a nursing home.

18. The computer-implemented system of claim 10 wherein said system capable of being integrated with modular software components for billing, pharmacy integration, document imaging and security.

19. The computer-implemented system of claim 10 wherein said network can be a local area network, wide area network or a global network of computers.

20. The computer-implemented system of claim 10 wherein said application software is further designed to restrict access to system files according to a hierarchical file access control.

21. The computer-implemented system of claim 10 wherein said application software is further designed to restrict access to system files according to pre-defined workflow constraints.

22. The computer-implemented system of claim 10 wherein said application software is further designed to include a scheduler which is capable of providing data to a system user at a pre-appointed time and place.

23. The computer-implemented system of claim 10 wherein said application software report generation capability also includes report generation for statistical analysis of all or a portion of the data in said relational database.

24. The computer-implemented system of claim 10 wherein said application software utilizes an automatic diagnosis tool to take information entered by a system user and group the appropriate elements into a pool of test results, findings, etc., that will in turn generate a proposed and suggested final outcome that can be modified by said system user.

25. A computer-implemented system for improving the efficiency of a business comprising:
a local computer, wherein said local computer is used for data input and retrieval;
a relational database, wherein said relational database is operationally connected to said local computer and receives data input and requests for data from said local computer;
a server computer wherein said server computer is operationally connected to said relational database and said local computer; and,
application software designed for inclusionary data entry, data retrieval and report generation, wherein said report generation is accomplished by accessing said relational database and the inclusionary data stored thereon.

26. The computer-implemented system of claim 25 wherein said local computer is a handheld computer.

27. The computer-implemented system of claim 25 wherein said system capable of being integrated with modular software components for billing, pharmacy integration, document imaging and security.

28. The computer-implemented system of claim 25 wherein said application software is further designed to restrict access to system files according to a hierarchical file access control.

29. The computer-implemented system of claim 25 wherein said application software is further designed to restrict access to system files according to pre-defined workflow constraints.

30. The computer-implemented system of claim 25 wherein said application software is further designed to include a scheduler which is capable of providing data to a system user at a pre-appointed time and place.

31. The computer-implemented system of claim 25 wherein said application software report generation capability also includes report generation for statistical analysis of all or a portion of the data in said relational database.

32. The computer-implemented system of claim 25 wherein said application software utilizes an automatic diagnosis tool to take information entered by a system user and group the appropriate elements into a pool of test results, findings, etc., that will in turn generate a proposed and suggested final outcome that can be modified by said system user.

33. A computer-implemented system for improving the efficiency of a medical service provider comprising:
a local computer, wherein said local computer is used for data input and retrieval;
a relational database, wherein said relational database is operationally connected to said local computer and receives data input and requests for data from said local computer;
a server computer wherein said server computer is operationally connected to said relational database and said local computer; and,
application software designed for inclusionary data entry, data retrieval and report generation, wherein said report generation is accomplished by accessing said relational database and the inclusionary data stored thereon.

34. The computer-implemented system of claim 33 wherein said local computer is a handheld computer.

35. The computer-implemented system of claim 33 wherein said system capable of being integrated with modular software components for billing, pharmacy integration and security.

36. A computer-implemented system of claim 33 wherein said local computer is located in a hospital.

37. The computer-implemented system of claim 33 wherein said local computer is located in a doctor's office.

38. The computer-implemented system of claim 33 wherein said local computer is located in a rehabilitation center.

39. The computer-implemented system of claim 33 wherein said local computer is located in a diagnostic center.

40. The computer-implemented system of claim 33 wherein said local computer is located in an extended living facility.

41. The computer-implemented system of claim 33 wherein said local computer is located in a nursing home.

42. The computer-implemented system of claim 33 wherein said application software is further designed to restrict access to system files according to a hierarchical file access control.

43. The computer-implemented system of claim 33 wherein said application software is further designed to restrict access to system files according to pre-defined workflow constraints.

44. The computer-implemented system of claim 33 wherein said application software is further designed to include a scheduler which is capable of providing data to a system user at a pre-appointed time and place.

45. The computer-implemented system of claim 33 wherein said application software report generation capability also includes report generation for statistical analysis of all or a portion of the data in said relational database.

46. The computer-implemented system of claim 33 wherein said application software utilizes an automatic diagnosis tool to take information entered by a system user and group the appropriate elements into a pool of test results, findings, etc., that will in turn generate a proposed and suggested final outcome that can be modified by said system user.

47. A method for improving the efficiency of a business comprising:
acquiring data to be input utilizing an inclusionary method;
inputting inclusionary data into a relational database;
processing data, wherein said processing is accomplished by a software application designed for inclusionary data entry, data retrieval and report generation, said report generation accomplished by accessing said relational database and the inclusionary data stored thereon;
accessing the data via a non-platform specific browser; and,
generating reports from the data at the request of said software application, wherein said report generation is performed in a standardized, pre-formatted manner.

48. The method of claim 47, wherein said method employs an additional step of generating billing with specific diagnostic codes.

49. The method of claim 47 wherein said data retrieval and accessing the data are governed by a hierarchical file access control.

50. The method of claim 47 wherein said data retrieval and accessing the data are governed according to pre-defined workflow constraints.

51. The method of claim 47 wherein said processing data further includes providing data to a system user at a pre-appointed time and place.

52. The method of claim 47 wherein said report generation includes statistical analysis of all or a portion of the data in said relational database.

53. The method of claim 47 wherein said processing takes information entered by a system user, groups the appropriate elements into a pool of test results, findings, etc., and generates a proposed and suggested final outcome that can be modified by said system user.

54. A method for improving the efficiency of a medical service provider comprising:
acquiring data to be input utilizing an inclusionary method, wherein said data is generated by a patient examination;
inputting inclusionary data into a relational database;
processing data, wherein said processing is accomplished by a software application designed for inclusionary data entry, data retrieval and report generation, said report generation accomplished by accessing said relational database and the inclusionary data stored thereon;
accessing the data via a non-platform specific browser; and,
generating reports from the data at the request of said software application, wherein said report generation is performed in a standardized, pre-formatted manner.

55. The method of claim 54, wherein said method employs an additional step of generating billing with specific diagnostic codes.

56. The method of claim 54, wherein said medical service provider is a hospital.

57. The method of claim 54, wherein said medical service provider is a doctor's office.

58. The method of claim 54, wherein said medical service provider is a rehabilitation center.

59. The method of claim 54, wherein said medical service provider is a diagnostic center.

60. The method of claim 54, wherein said medical service provider is an extended living facility.

61. The method of claim 54, wherein said medical service provider is a nursing home.

62. The method of claim 54 wherein said data retrieval and accessing the data are governed by a hierarchical file access control.

63. The method of claim 54 wherein said data retrieval and accessing the data are governed according to pre-defined workflow constraints.

64. The method of claim 54 wherein said processing data further includes providing data to a system user at a pre-appointed time and place.

65. The method of claim 54 wherein said report generation includes statistical analysis of all or a portion of the data in said relational database.

66. The method of claim 54 wherein said processing takes information entered by a system user, groups the appropriate elements into a pool of test results, findings, etc., and generates a proposed and suggested final outcome that can be modified by said system user.

67. A computer-readable medium storing computer executable instructions for performing the steps of:
acquiring data to be input utilizing an inclusionary method;
inputting inclusionary data into a relational database;
processing data;
accessing the data via a non-platform specific browser; and,
generating reports from the data at the request of said executable instructions, wherein said report generation is performed in a standardized, pre-formatted manner.

68. The computer readable medium of claim 67 wherein said executable instructions are further designed to restrict access to system files according to pre-defined workflow constraints.

69. The computer readable medium of claim 67 wherein said executable instructions are further designed to provide a hierarchical file access control.

70. The computer readable medium of claim 67 wherein said executable instructions are further designed to provide billing with specific diagnostic codes.

71. The computer readable medium of claim 67 wherein said executable instructions are further designed to provide data to a system user at a pre-appointed time and place.

72. The computer readable medium of claim 67 wherein said executable instructions are further designed to provide statistical analysis of all or a portion of the data in said relational database.

73. The computer readable medium of claim 67 wherein said processing takes information entered by a system user, groups the appropriate elements into a pool of test results, findings, etc., and generates a proposed and suggested final outcome that can be modified by said system user.
